(19) United States
(12) Patent Application Publication
(10) Pub. No.: US 2009/0272161 A1
(43) Pub. Date: Nov. 5, 2009

(54) Cylinder and Associated Key

(75) Inventor: Enzo Talamonti, Ascoli Piceno (IT)

Correspondence Address: MODIANO & ASSOCIATI, Via Meravigli 16, Milan, 20123, IT

(73) Assignee: CISA S.P.A., Faenza (IT)

(21) Appl. No.: 12/308,096

(22) PCT Filed: Jun. 5, 2007
(86) PCT No.: PCT/EP2007/004979

§ 371 Date: Dec. 8, 2008

(30) Foreign Application Priority Data
Jun. 14, 2006 (EP) 06425401.4

(51) Int. Cl. E05B 27/00

(52) U.S. Cl. 70/491

(57) ABSTRACT

A cylinder with associated key, comprising a stator provided with a longitudinal cavity for accommodating a rotor with a longitudinal recess for the insertion of a coded key. The rotor and the stator comprise channels for accommodating respective pins, complementary pins and any elastic elements. The rotor comprises at least one second passage, the passage and the cavity accommodating at least one respective movable peg, whose head rests against the blade edge of the key when the key is inserted in the recess. The key is provided with suitable contoured regions on its blade edge at the surfaces that face said pegs when inserted in the recess. Each peg has its base inside the respective cavity so as to block the rotation of the rotor with respect to the stator when a key lacking the corresponding contoured regions is inserted.

The present invention relates to a cylinder with an associated key suitable for installation in doors, entrance doors and in all applications in which a key-controlled closure is provided.

### BACKGROUND OF THE INVENTION

There are various kinds of lock with respective keys, which achieve the task of closing securely a door by using a variety of different solutions against any picking attempts.

Among cylinder locks, there is considerable interest in those in which the keyway (and therefore also the corresponding key) is substantially flat and in which the pins designed to detect the key act substantially transversely with respect to the keyway (thus acting on flat portions of the key).

These locks are generally identified by the type of key associated with them and are known as flat-key locks.

The risk of picking is avoided by means of the complex coding of the cylinder and of the key: particular picking actions allow to actuate the pins to open the lock even without the original key.

In view of the small dimensions of a lock of the type being considered, it is substantially not possible to increase the number of pins in order to ensure greater security against picking.

### SUMMARY OF THE INVENTION

The aim of the present invention is to provide a cylinder with corresponding key of traditional size which is provided with portions adapted to increase the complexity of any picking actions.

Within this aim, an object of the present invention is to provide a cylinder with associated key which has a low cost, is relatively simple to provide, and is practical and safe in application.

This aim and this and other objects that will become better apparent hereinafter are achieved by the present cylinder with associated key of the type comprising a stator provided with a substantially cylindrical longitudinal cavity for accommodating a rotor with a longitudinal recess for the insertion of a coded key, said rotor and said stator comprising a plurality of channels, which are substantially aligned and face each other when the cylinder is in the closed configuration, channels for accommodating respective pins, complementary pins and any elastic means intended to prevent the rotation of the rotor within the stator if the key is not present in said longitudinal recess, characterized in that said rotor comprises at least one second passage, which is not aligned with respect to said channels and faces, in the closed configuration of the cylinder, a corresponding cavity of the stator, said passage and said cavity accommodating at least one respective movable peg whose head rests against the edge of the blade of the key when said key is inserted in the recess, said key being provided with contoured regions on its blade edge at the surfaces that face said pegs when inserted in the recess, said peg having its base inside the respective cavity so as to block the rotation of the rotor with respect to the stator when a key lacking the corresponding contoured regions is inserted.

### BRIEF DESCRIPTION OF THE DRAWINGS

Further characteristics and advantages will become better apparent from the following detailed description of a preferred but not exclusive embodiment of a cylinder and associated key, illustrated only by way of non-limiting example in the accompanying drawings, wherein:

FIG. 1 is a sectional top view, taken along a horizontal transverse plane, of a cylinder with a key according to the invention in the open condition;

FIG. 2 is a sectional side view, taken along a vertical longitudinal plane, of a cylinder with a key according to the invention in the open condition;

FIG. 3 is a sectional view, taken along the line III-III of FIG. 2, of a cylinder with a key according to the invention in the open condition;

FIG. 4 is a sectional view, taken along the line IV-IV of FIG. 2, of a cylinder with a key according to the invention in the open condition;

FIG. 5 is a sectional view, taken along the line III-III of FIG. 2, of a cylinder with a key according to the invention in a configuration which is rotated with respect to FIG. 3 in the open condition;

FIG. 6 is a sectional view, taken along the line IV-IV of FIG. 2, of a cylinder with a key according to the invention in a configuration which is rotated with respect to FIG. 4 in the open condition;

FIG. 7 is a sectional top view, taken along a horizontal transverse plane, of a cylinder with a key according to the invention in the non-opening condition, the contoured regions of said key being positioned improperly;

FIG. 8 is a sectional side view, taken along a longitudinal plane, of a cylinder with a key according to the invention in the open condition;

FIG. 9 is a sectional view, taken along the line IX-IX of FIG. 8, of a cylinder with a key according to the invention in the open condition;

FIG. 10 is a sectional view, taken along the line X-X of FIG. 8, of a cylinder with a key according to the invention in the non-opening condition;

FIG. 11 is a sectional view, taken along the line IX-IX of FIG. 8, of a cylinder, with an inappropriate key inserted therein, according to the invention, in a configuration which is rotated with respect to FIG. 9, in a non-opening condition.

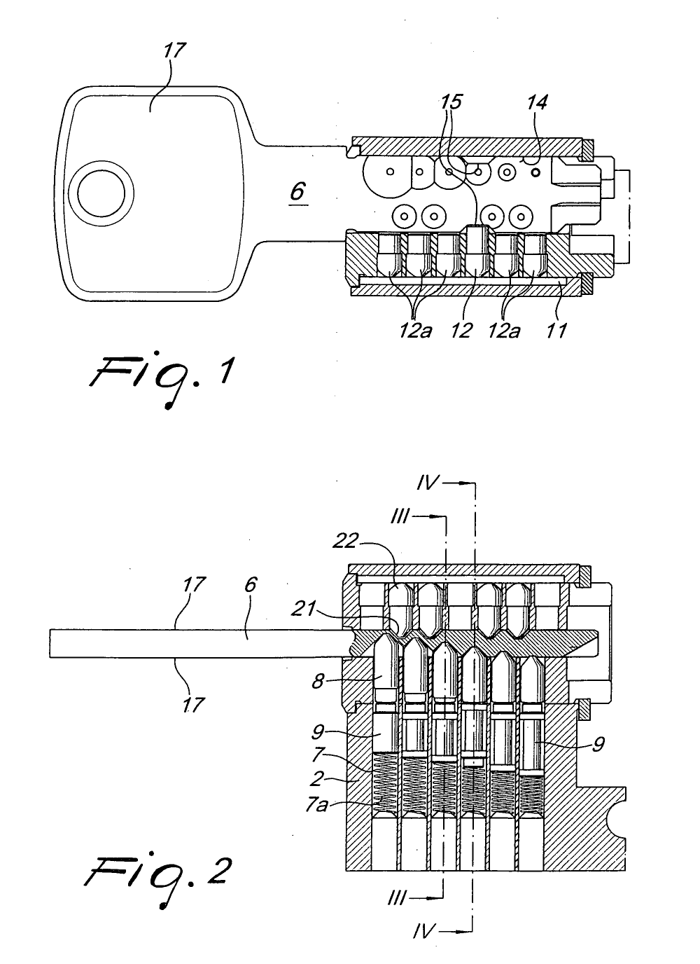

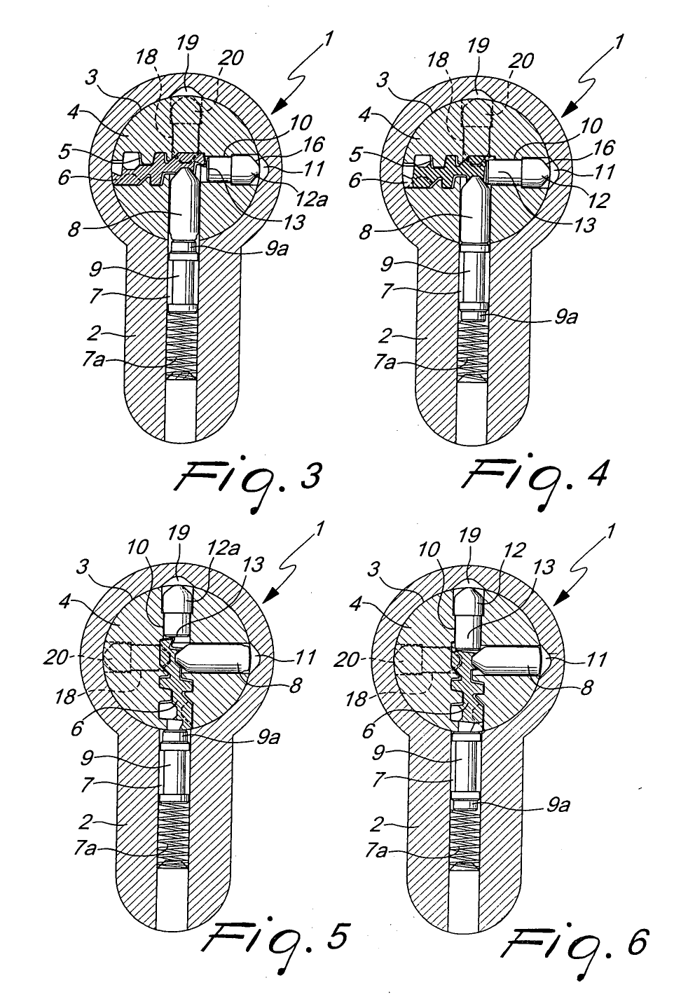

### DESCRIPTION OF THE PREFERRED EMBODIMENTS

With reference to the figures, the reference numeral 1 generally designates a cylinder and an associated key.

The cylinder 1 comprises a stator 2 provided with a substantially cylindrical longitudinal cavity 3 for accommodating a rotor 4 with a longitudinal recess 5 for the insertion of a coded key 6.

The rotor 4 and the stator 2 comprise a plurality of channels 7, which are substantially aligned and face each other when the cylinder 1 is in the closed configuration.

The containment channels 7 are designed to accommodate respective pins 8, complementary pins 9 and optional elastic means 7a: the purpose of the pins 8 and complementary pins 9 is to prevent the rotation of the rotor 4 within the stator 2 if the key 6 is not present in the longitudinal recess 5.

The rotor 4 comprises at least one second passage 10, which is not aligned with the channels 7 and faces, in the closed configuration of the cylinder 1, a corresponding opening 11 of the stator 2: the passage 10 is substantially cylindrical and comprises generally a portion at which its diameter changes, having a larger diameter in the radially outermost portion.

According to the embodiments shown in the figure, the passages 10 and the respective cavities 11 can be a plurality and can be mutually aligned along the longitudinal extension of the cylinder 1; it is actually possible to provide a cylinder which has a single passage 10 (and a corresponding cavity 11) or a limited number thereof distributed in any manner in order to match the requirements of the manufacturer.

The passage 10 and the cavity 11 accommodate at least one respective movable peg 12, the head 13 of which rests against at least one portion of the edge of the blade of the key 6 when said key is inserted in the recess 5.

The diameter variation of each passage 10 is linked to the fact that the respective peg 12 also has a corresponding variation in diameter, so as to prevent, if no key is inserted in the recess 5, the peg 12 from escaping and falling into the recess 5. The diameter variation identifies an abutment border, against which the peg 12 can rest its surface of discontinuity, thus remaining within its seat.

Conveniently, the key 6 is therefore provided with suitable contoured regions 15 on the blade edge 14 at the surfaces that face the pegs 12 when the key is inserted in the recess 5.

Further, the peg 12 keeps its base 16 within the respective cavity 11, so as to block the rotation of the rotor 4 with respect to the stator 2 when a key 6 lacking the corresponding contoured regions 15 is inserted: if the peg 12 is pushed out of the passage 10 (with its base 16 within the cavity 11), as a consequence of the presence of a key 6 lacking the contoured regions 15 within the recess 5, opening of the cylinder 1 is thus prevented.

To ensure correct operation of the cylinder 1 according to the invention, the passage 10 should be perpendicular to the channels 7 and accordingly the cavity 11 should be in a corresponding position.

The channels 7 face one of the flat and opposite surfaces 17 of the key 6 and the passage 10 faces one of the blade edge portions 14 of the key 6; conveniently, if the key 6 is the one associated with the cylinder 1, the passage faces the corresponding contoured region 15.

The contoured regions 15 of the blade edge 14 of the key 6 are symmetrical in order to allow the insertion of the key 6 in the recess 5 in both possible configurations: therefore, the user does not have to conform to a particular orientation of insertion of the key 6 in order to open the cylinder 1, but no matter how the key 6 is inserted, it allows opening.

The axis of symmetry of one of the passages 10 and of the corresponding cavity 11 lies on a plane which is transverse to the cylinder 1 and contains the axis of symmetry of a respective channel 7: in practice, each passage 10 is coplanar with respect to a respective channel 7.

The key 6 is symmetrical with respect to an inclined plane which passes through two mutually opposite edges of its coded portion, which is substantially shaped like a parallelepiped: in practice, the coding pattern provided on the mutually opposite surfaces 17 is the same, but it is provided mirror-symmetrically in one with respect to the other; the contoured regions 15 of the blade edge portions 14 are instead correspondingly aligned with each other.

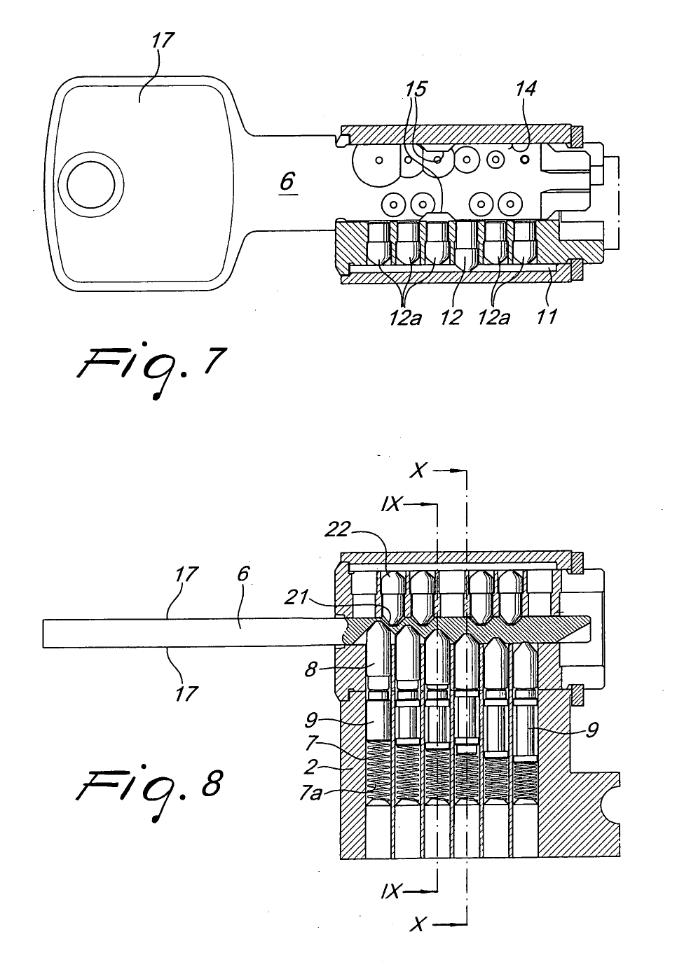

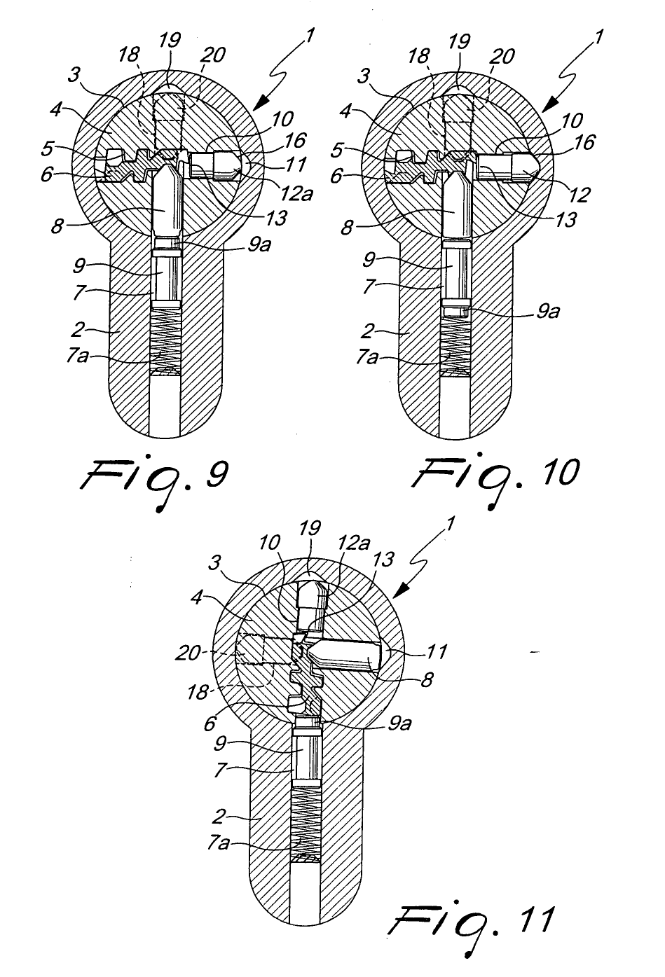

The cavity 11 of the stator 2 is a longitudinal slot, as can be seen clearly in FIG. 1 and in FIG. 7: the main advantage of this type of embodiment is that with a single slot the provision of the entire cylinder 1 according to the invention is simplified considerably.

The cylinder 1 is provided with ducts 18, which are not aligned and are arranged opposite the channels 7: a respective longitudinal groove 19 of the stator 2 corresponds to each of these ducts 18.

The ducts 18 accommodate, so that they can perform a translational movement, respective dowels 20, which have a head 22 adapted to rest against the coded surface 17 of the key 6.

The bottom 21 of each dowel 20 is inserted with interference in the longitudinal groove 19 when the key 6, inserted in the recess 5, does not have the correct coding: in this manner, the dowels 20 also help to prevent the rotation of the rotor 4 in the stator 2 if an incorrectly coded key 6 is used.

It should also be specified that in the cylinder 1 according to the invention, the complementary pins 9 are not symmetrical (with respect to a transverse plane that passes through their centerline, as in traditional applications) and in fact have a head 9a having a smaller diameter at one of their ends: the orientation of the assembly of the complementary pins 9 thus shaped must be determined depending on the presence or absence of the contoured regions 15 (which may be more than one pair for each key 6).

The complementary pins 9 must be oriented so that the head 9a is directed toward the rotor 4, therefore towards the blade edge 14 of the key in the positions where the contoured regions 15 are not present.

In positions in which the contoured regions 15 are instead provided, the complementary pin 9 must be oriented in the opposite way, i.e., with the larger diameter toward the rotor 4, therefore, towards the blade edge 14, on the contoured region 15 of the key 6: this prevents the complementary pin 9 from entering the empty space of the broaching (recess 5).

This assembly system allows an additional check on false keys 6, since by combining the various possible combinations of the contoured regions 15 on the blade edge 14 of the key 6 with specific key profiles 6 (i.e., different contours of the recesses 5) or/and specific coding patterns of the pins 8 (the active ones) and 20 (the passive ones), it is possible to affect and block the rotation, therefore the opening of the cylinders 1 that might be actuated with keys 6 that have been forged also in the contoured regions 15 of the blade edge 14, forming contoured regions at all positions or not performing any contouring or with contoured regions in improper positions.

In fact, even if said forged keys 6 unfortunately succeeded in cloning the normal coding that protects the cylinder 1 (the profile that enters the recess 5, the alignment of the active and passive pins 8 and 20), it would still not be possible to open the cylinder 1, since in the case of a key with cutout blade edges or in an improper position, the rotor 4 might begin rotation, but when the blade edge 14 of the key 6 passes at the head 9a of the complementary pin 9, it would enter the recess 5, occupying the space left empty by the slot 15 (which is inappropriate due to forgery) on the blade edge 14.

At this point, the rotor 4 remains blocked, cannot rotate forward or backward, and the forged key cannot be extracted and therefore remains trapped.

If instead the forged key 6 has no contoured regions 15 on the blade edge or has them in an incorrect position, the lateral pin 12 rests against the blade edge 14 of the key 6, and by being unable to penetrate the recess 5 is blocked on the cavity 11, preventing the beginning of the rotation of the rotor 4. In this condition it is still possible to extract the key 6.

Moreover, not all the lateral pins 12 are identical: only the one that interacts with the contoured region 15 of the key 6 is in fact longer; the other ones are shorter, do not interact with the blade edge 14 of the key 6 and in practice merely act as a plug.

It has thus been shown that the invention achieves the intended aim and object.

The invention thus conceived is susceptible of numerous modifications and variations, all of which are within the scope of the appended claims.

All the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and the dimensions, may be any according to requirements without thereby abandoning the scope of the protection of the appended claims.

The disclosures in European Patent Application No. 06425401.4 from which this application claims priority are incorporated herein by reference.

What is claimed is:

1-9. (canceled)

10. A cylinder with associated key of the type comprising a stator provided with a substantially cylindrical longitudinal cavity for accommodating a rotor with a longitudinal recess for the insertion of a coded key, said rotor and said stator comprising a plurality of channels, which are substantially aligned and face each other when the cylinder is in the closed configuration, channels for accommodating respective pins, complementary pins and any elastic means intended to prevent the rotation of the rotor within the stator if the key is not present in said longitudinal recess, wherein said rotor comprises at least one second passage, which is not aligned with respect to said channels and faces, in the closed configuration of the cylinder, a corresponding cavity of the stator, said passage and said cavity accommodating at least one respective movable peg whose head rests against the edge of the blade of the key when said key is inserted in the recess, said key being provided with contoured regions on its blade edge at the surfaces that face said pegs when inserted in the recess, said peg having its base inside the respective cavity so as to block the rotation of the rotor with respect to the stator when a key lacking the corresponding contoured regions is inserted.

11. The cylinder and the associated key according to claim 10, wherein said at least one second passage is perpendicular to said channels, which face one of the flat and mutually opposite surfaces of the key, said second passage facing one of the blade edge portions of said key.

12. The cylinder and the associated key according to claim 10, wherein said second passages are a plurality and are distributed along the entire depth of said cylinder at the area of the recess in which the coded region of said key is accommodated.

13. The cylinder and the associated key according to claim 10, wherein said contoured regions of said key are symmetrical, in order to allow the insertion of said key in the recess in both of its possible configurations.

14. The cylinder and the associated key according to claim 10, wherein the axis of symmetry of one of said second passages and of the corresponding opening lies on the plane that is arranged transversely to the cylinder and contains the axis of symmetry of a respective channel.

15. The cylinder and the associated key according to claim 10, wherein said key is symmetrical with respect to an inclined plane which passes through two mutually opposite edges of a coded portion of the key, which coded portion is shaped substantially like a parallelepiped.

16. The cylinder and the associated key according to claim 10, wherein said cavity of said stator is a longitudinal slot.

17. The cylinder and the associated key according to claim 10, further comprising ducts, which are not aligned and are arranged opposite said channels and correspond to a respective longitudinal groove of the stator.

18. The cylinder and the associated key according to claim 17, wherein said ducts accommodate, so that they can perform a translational motion, respective dowels whose head is adapted to rest against the coded surface of said key and whose bottom is inserted with interference in said longitudinal groove when the key inserted in the recess does not have the correct coding, preventing the rotation of the rotor in the stator.
